(19) United States
(12) Patent Application Publication
(10) Pub. No.: US 2026/0300541 A1
(43) Pub. Date: Oct. 1, 2026

(54) STORAGE MEDIUM STORING PROGRAM ENABLING TRANSMISSION OF PROMPT, INFORMATION PROCESSING APPARATUS, AND METHOD OF CONTROLLING INFORMATION PROCESSING APPARATUS

(71) Applicant: CANON KABUSHIKI KAISHA, Tokyo (JP)

(72) Inventor: TAMAO SATO, Kanagawa (JP)

(21) Appl. No.: 19/574,937

(22) Filed: Mar. 23, 2026

(30) Foreign Application Priority Data
Mar. 25, 2025 (JP) 2025-049659

(51) Int. Cl. G06F 21/62; G06F 40/295; G06F 40/40; G06T 5/60

(52) U.S. Cl. CPC G06F 21/6245; G06F 40/295; G06F 40/40; G06T 5/60

(57) ABSTRACT

A program causes a computer of an information processing apparatus to execute a method including receiving a first prompt, transmitting, in a case where personal identification information is included in the first prompt, a second prompt to an external apparatus having a learned model, the second prompt including concealed information formed by converting the personal identification information such that the personal identification information can be concealed, and outline information indicating the information, receiving an output result obtained by inputting the second prompt to the learned model, and converting the concealed information included in the output result to the personal identification information.

### BACKGROUND

### Field of the Technology

The present disclosure relates to a storage medium storing a program enabling transmission of a prompt, an information processing apparatus, and a method of controlling the information processing apparatus.

### Description of the Related Art

In recent years, there is a case where a generative AI is used e.g. in a business scene. Examples of this case include causing the generative AI to create a material used for a work and causing the generative AI to assist creation of a source code. In these cases, when transmitting data to the generative AI, a user using the generative AI preferably transmits the data after confirming that personal information is not included in this data, but transmission of the data can be performed in a state in which personal information is erroneously included in the data e.g. due to a human error. For example, Japanese Laid-Open Patent Publication (Kokai) No. 2023-27525 discloses an information processing apparatus that determines whether or not to transmit data according to the data and a situation.

For example, when an instruction for generating an image for a New Year's Card with a person's face photograph is given, a prompt including personal information, such as a person's face photograph, is sometimes transmitted to the generative AI on a cloud. However, regardless of whether or not personal information is included in the prompt, the prompt is input to the generative AI on the cloud, and the generative AI performs outputting of the prompt. Therefore, in a case where personal information is included in the prompt, the personal information can be leaked. The generative AI includes, not only the generative AI on the cloud, but also a generative AI incorporated e.g. in a desktop-type or laptop-type personal computer, i.e. an on-device generative AI. In this on-device generative AI, an executable range tends to be more limited than that of the generative AI on the cloud, and hence there is a possibility that an output result expected by the user cannot be obtained depending on the content of a prompt.

### SUMMARY

The present disclosure is directed to providing a storage medium storing a program enabling transmission of a prompt without being conscious of whether or not the prompt includes personal identification information based on which a person can be identified, an information processing apparatus, and a method of controlling the information processing apparatus.

In a first aspect of the present disclosure, there is provided a non-transitory computer-readable storage medium storing a program for executing a method of controlling an information processing apparatus communicably connected to an external apparatus having a learned model, the program causing a computer of the information processing apparatus to execute the method including receiving a first prompt, transmitting, in a case where personal identification information is included in the first prompt, a second prompt to the external apparatus, the second prompt including concealed information formed by converting the personal identification information such that the personal identification information can be concealed, and outline information which is information indicating the personal identification information but does not include the personal identification information, receiving an output result obtained by inputting the second prompt transmitted by the transmitting to the learned model, and converting the concealed information included in the output result received by the receiving to the personal identification information.

In a second aspect of the present disclosure, there is provided an information processing apparatus that is communicably connected to an external apparatus having a learned model, including a reception unit configured to receive a first prompt, a transmission unit configured to transmit, in a case where personal identification information is included in the first prompt, a second prompt to the external apparatus, the second prompt including concealed information formed by converting the personal identification information such that the personal identification information can be concealed, and outline information which is information indicating the personal identification information but does not include the personal identification information, a transmission receiving unit configured to receive an output result obtained by inputting the second prompt transmitted by the transmission unit to the learned model, and a conversion unit configured to convert the concealed information included in the output result received by the transmission receiving unit to the personal identification information.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example of a configuration of an information processing system.

FIGS. 2A and 2B are block diagrams showing an example of hardware configurations of an information processing apparatus and a cloud, respectively.

FIGS. 3A and 3B are block diagrams showing an example of software configurations of the information processing apparatus and the cloud, respectively.

FIG. 3C is a diagram showing an example of personal identification information (personal information).

FIG. 3D is a diagram showing an example of one set of an unprocessed image and a processed image.

FIGS. 4A and 4B are diagrams each showing an example of personal identification information.

FIGS. 5A to 5D are diagrams showing an example of screens for setting a generative AI used in the information processing system.

FIGS. 6A and 6B are diagrams each showing an example of a prompt execution screen (GUI) displayed in a case where a desired result is obtained by using a generative AI.

FIG. 7 is a sequence diagram showing a process executed between a user, a generative AI-setting section, connection information, and a generative AI.

FIGS. 8A to 8F are diagrams showing an example of varying states of the personal identification information.

FIGS. 9A and 9B are flowcharts of a process performed by the information processing apparatus and the cloud.

FIG. 10 is a sequence diagram showing a process executed between the user, a prompt execution section, an image data group, and a database.

### DESCRIPTION OF THE EMBODIMENTS

The present disclosure will now be described in detail below with reference to the accompanying drawings showing embodiments thereof. Configurations described in the following embodiments are given only by way of example, and are by no means intended to limit the scope of the present disclosure. For example, components of the configurations of the present disclosure can be replaced with desired components which can exhibit the same functions. Further, desired components can be added. Further, in the present embodiment, an AI (artificial intelligence) refers to a technology that enables a computer to execute tasks of learning, understanding, solution of a problem, decision, and creativity, by imitating human intelligence.

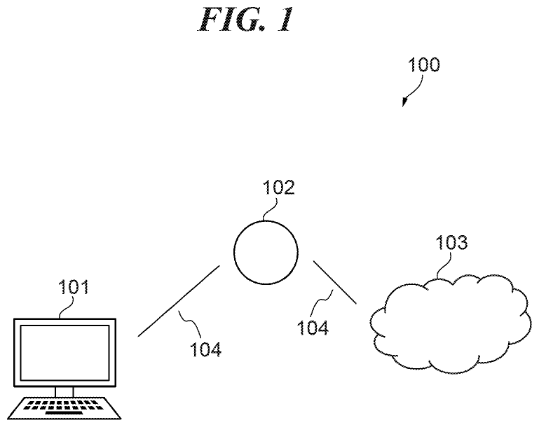

FIG. 1 is a diagram showing an example of a configuration of an information processing system. As shown in FIG. 1, the information processing system, denoted by reference numeral 100, includes an information processing apparatus 101 and a cloud (external apparatus) 103. Further, in the information processing system 100, the information processing apparatus 101 and the Internal 102 are connected via a network 104, and the cloud 103 and the Internet 102 are also connected via the network 104. With this, the information processing apparatus 101 and the cloud 103 are communicably connected to each other. Note that the configuration of a general-purpose computer realizing the cloud 103 is not particularly limited, but, for example, a configuration using hardware resources supplied by a virtualization technique on demand can be used.

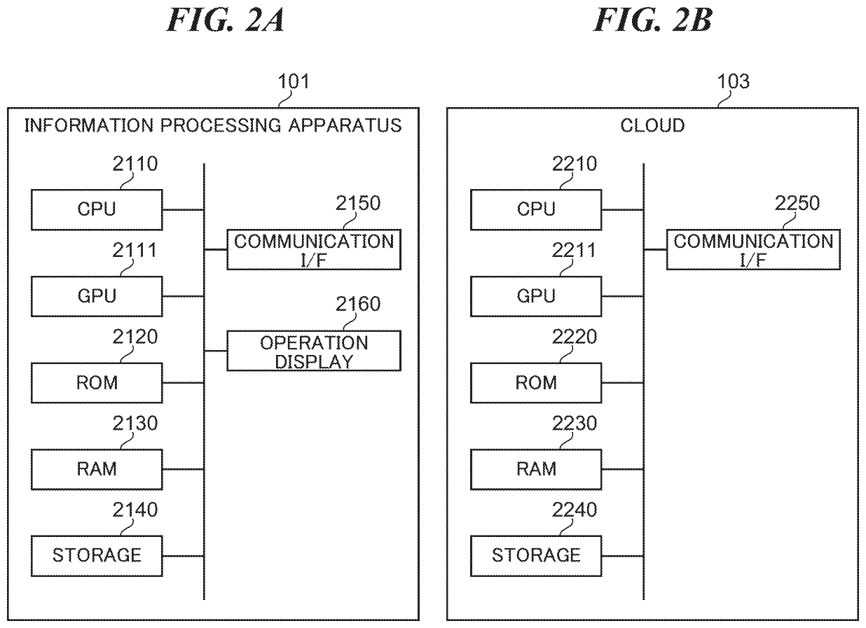

FIGS. 2A and 2B are block diagrams showing an example of hardware configurations of the information processing apparatus and the cloud, respectively. FIG. 2A is a block diagram showing an example of the hardware configuration of the information processing apparatus. FIG. 2B is a block diagram showing an example of the hardware configuration of the cloud. As shown in FIG. 2A, the information processing apparatus 101 includes a central processing unit (CPU) 2110, a graphics processing unit (GPU) 2111, a read only memory (ROM) 2120, a random access memory (RAM) 2130, a storage 2140, a communication interface (I/F) 2150, and an operation display 2160. The CPU 2110 is a computer that controls the overall operation of the information processing apparatus 101. The CPU 2110 reads out a control program (program) stored in the ROM 2120 or the storage 2140. This control program enables the CPU 2110 to execute steps (a method of controlling the information processing apparatus), described hereinafter. Further, the control program enables the CPU 2110 to execute a variety of control functions for printing, reading, and so forth, execute calculation of data, and so forth. In a case where the AI or the generative AI (learned model) is used, the execution of a variety of control functions, the calculation of data, and so forth are caused to be performed by the GPU 2111. Note that in place of the GPU 2111, for example, a general-purpose graphics processing unit (GPGPU), an accelerated processing unit (APU), a tensor processing unit (TPU), or the like can be used.

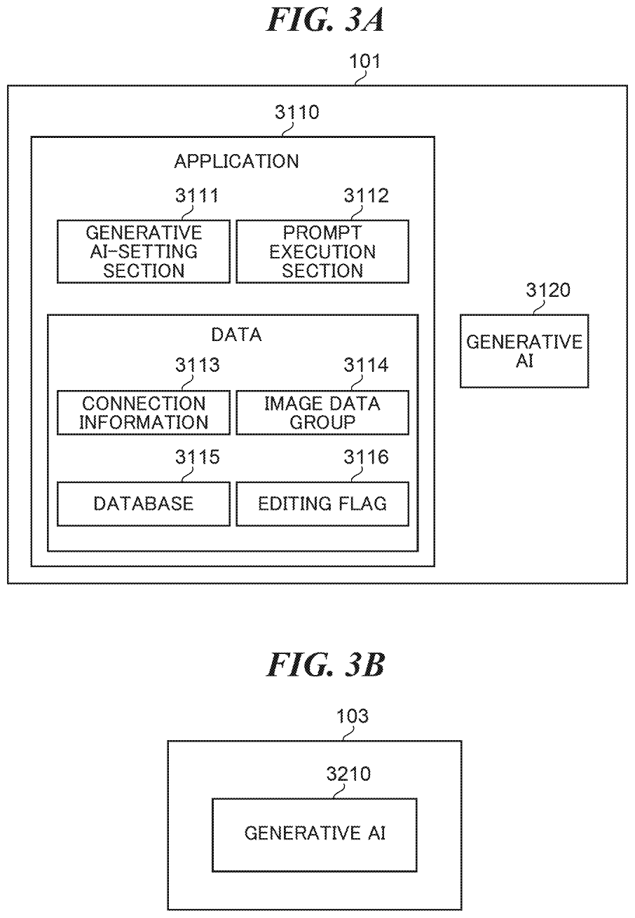

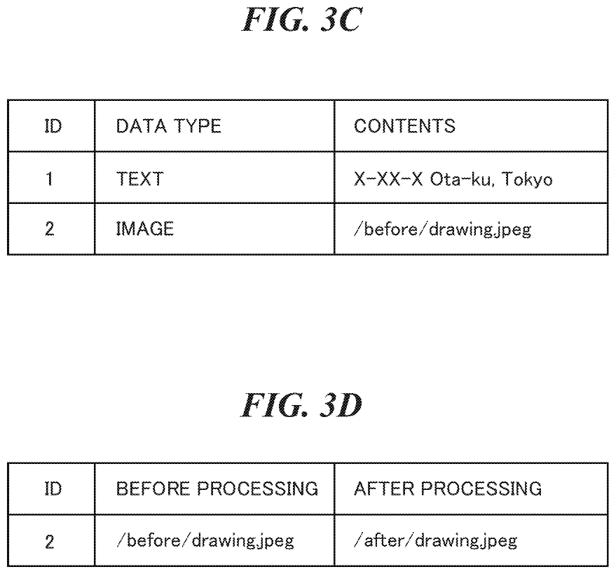

The RAM 2130 functions as a main storage memory for the CPU 2110. Further, the RAM 2130 is also used as a temporary storage area for loading a variety of control programs stored in the ROM 2120 and the storage 2140. The storage 2140 stores not only the control programs, but also print data, image data, a variety of programs, a variety of setting information, and so forth. The communication I/F 2150 is an interface for communicating with an external apparatus, such as the cloud 103. The operation display 2160 performs display by a generative AI-setting section 3111 (see FIG. 3A), display by a prompt execution section 3112 (see FIG. 3A), reception of an input from a user using the information processing apparatus 101, and so forth. The prompt refers to an instruction, a question, or the like, which is input by a user. Note that in the present embodiment, as the prompt, there are a first prompt and a second prompt, as described hereinafter.

As shown in FIG. 2B, the cloud 103 includes a CPU 2210, a GPU 2211, a ROM 2220, a RAM 2230, a storage 2240, and a communication I/F 2250. The CPU 2210 is a computer that controls the overall operation of the cloud 103. The CPU 2210 reads out a control program stored in the ROM 2220 or the storage 2240. This control program enables the CPU 2210 to execute a variety of control functions for printing, reading, and so forth, execute calculation of data, and so forth. In a case where the generative AI is used, the variety of control functions, the calculation of data, and so forth are performed by using the GPU 2211.

The RAM 2230 functions as a main storage memory for the CPU 2210. Further, the RAM 2230 is also used as a temporary storage area for loading a variety of control programs stored in the ROM 2220 and the storage 2240. The storage 2240 stores not only the control programs, but also print data, image data, a variety of programs, a variety of setting information, and so forth. The communication I/F 2250 is an interface for communicating with the information processing apparatus 101 and the like. Note that the hardware components forming the cloud 103, such as the CPU 2210 and the ROM 2220, are supplied by a virtual technique on demand. With this, the cloud 103 is configured as a virtual server on a cloud computing environment.

FIGS. 3A and 3B are block diagrams showing an example of software configurations of the information processing apparatus 101 and the cloud 103, respectively. FIG. 3A is a block diagram showing an example of the software configuration of the information processing apparatus 101. FIG. 3B is a block diagram showing an example of the software configuration of the cloud 103. FIG. 3C is a diagram showing an example of personal identification information (personal information). FIG. 3D is a diagram showing an example of one set of an unprocessed image and a processed image. As shown in FIG. 3A, the information processing apparatus 101 includes an application 3110 and a generative AI 3120. The application 3110 is capable of setting a generative AI to be used, and inputting/outputting a prompt to and from the generative AI. Specifically, the application 3110 includes the generative AI-setting section 3111 and the prompt execution section 3112. The generative AI-setting section 3111 and the prompt execution section 3112 are controlled by the CPU 2110. Further, the application 3110 includes a variety of information of connection information 3113, an image data group 3114, a database 3115, and an editing flag 3116. Note that although in the present embodiment, the connection information 3113, the image data group 3114, the database 3115, and the editing flag 3116 are provided within the information processing apparatus 101, this is not limitative, but for example, they can be provided outside the information processing apparatus 101.

The generative AI-setting section 3111 displays a setting screen on the operation display 2160 to set the generative AI to be used. In the connection information 3113, information set by the generative AI-setting section 3111 is held. This information is held in a text format in the present embodiment, but this is not limitative.

The database 3115 stores personal identification information and images (hereinafter referred to as the unprocessed images), each included in a prompt input to the prompt execution section 3112, images (hereinafter referred to as the processed images) generated by processing the unprocessed images, respectively, and so forth. In the database 3115, each unprocessed image and each processed image are stored in a state associated with each other, i.e. stored as one set (pair). The personal identification information is information based on which a person can be identified. The generative AI 3120 is a generative AI operating in the information processing apparatus 101 and has a learned model which has learned personal identification information. With this, the generative AI 3120 can determine whether or not personal identification information is included in a prompt (determination step). Further, the generative AI 3120 is capable of determining the content of a prompt, rewriting a prompt, and processing an image attached to a prompt.

The personal identification information has, for example, an ID and a data type (such as text and image), which are set for each one data item. The ID is set by the prompt execution section 3112, for identifying the personal identification information. Note that the ID can be a serial number, but a desired number can be set. For example, in a case where a user inputs “Input an address of X-XX-X Ota-ku, Tokyo” to the prompt execution section 3112, the specific address of “X-XX-X Ota-ku, Tokyo” is determined as the personal identification information. In this case, the prompt execution section 3112 sets a unique identifier as the ID, sets “text” as the data type, and sets “X-XX-X Ota-ku, Tokyo” as the content of the prompt. These pieces of information are stored in the database 3115. In the database 3115, for example, the information shown in FIG. 3C is stored. As shown in FIG. 3C, two data items of the personal identification information are stored, and for one of the data items, the ID is set to “1”, the data type is set to “text”, and the content of the prompt is set to “X-XX-X Ota-ku, Tokyo”. Further, for the other of the data items, the ID is set to “2”, the data type is set to “image”, and the content of the prompt is set to “/before/drawing.jpeg”. Note that although in the present embodiment, as the information for each data, the ID, the data type, and the content of the prompt are set, this is not limitative. Further, the method of the machine learning algorithm used in the generative AI 3120 (learned model) is not particularly limited, and for example, deep learning, support vector machine, logistic regression, and decision tree can be used.

With respect to one set of an unprocessed image and a processed image, for example, an ID, a storage location (storage destination) of the unprocessed image, and a storage location (storage destination) of the processed image are set for each set of data. The ID is used for identifying the personal identification information. The storage location of the unprocessed image and the storage location of the processed image are both set as addresses. For example, in FIG. 3D, the ID is set to “2”, the storage location of the unprocessed image is set to “/before/drawing.jpeg”, and the storage location of the processed image is set to “/after/drawing.jpeg”. Note that, although in the present embodiment, as the information set for one set of data, the ID, the storage location of the unprocessed image, and the storage location of the processed image are set, this is not limitative. In the image data group 3114, the unprocessed images input to the prompt execution section 3112 and the processed images processed by the generative AI 3120 are stored. Further, in the image data group 3114, the storage location of the image data group 3114 is added.

The editing flag 3116 manages whether or not a prompt and attached data attached to this prompt have been edited by the prompt execution section 3112. For initial values of the prompt and the attached data, a flag is set to OFF. Then, in a case where the prompt and the attached data have been edited, the editing flag 3116 sets the flag to ON. Note that although the flag is used for management of whether or not a prompt and attached data have been edited, this is not limitative.

As shown in FIG. 3B, the cloud 103 has a generative AI 3210. Similar to the generative AI 3120, the generative AI 3210 has a learned model. Note that the generative AI 3210 is not particularly limited, but, for example, Chat GPT, Copilot, or the like can be used. The generative AI 3210 can be obtained by causing a neural network to perform deep learning. To the generative AI 3210, a prompt (instruction) including data for inference, such as audio data, text data, and image data, is input. The generative AI 3210 infers the data for inference according to the prompt and outputs a result of the inference in a data format of audio data or text data. Here, inference refers to, for example, analysis, classification, prediction, and summarization. Further, the generative AI 3210 can have a plurality of types of learned models, for example. For example, when desired to obtain a plurality of inference results which are different in type from each other, the learned models can be made as the learned models suitable for the respective inferences.

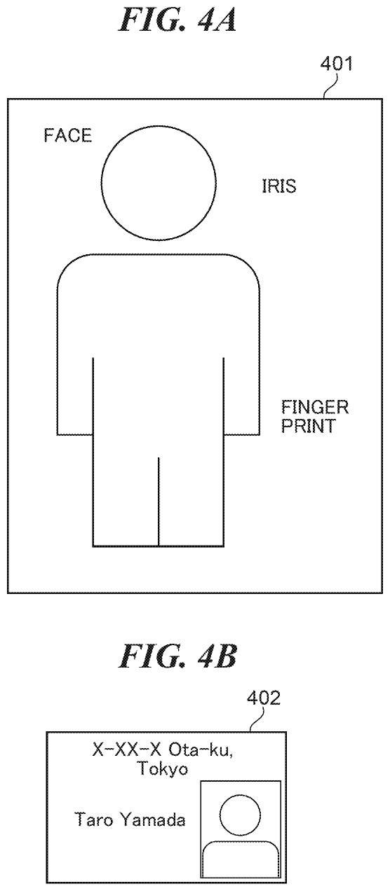

FIGS. 4A and 4B are diagrams each showing an example of personal identification information. Personal identification information 401 shown in FIG. 4A is an image of a human body including a face, an iris, a fingerprint, and so forth. Personal identification information 402 shown in FIG. 4B is an image of a business card including an address, a name, a face photograph, and so forth.

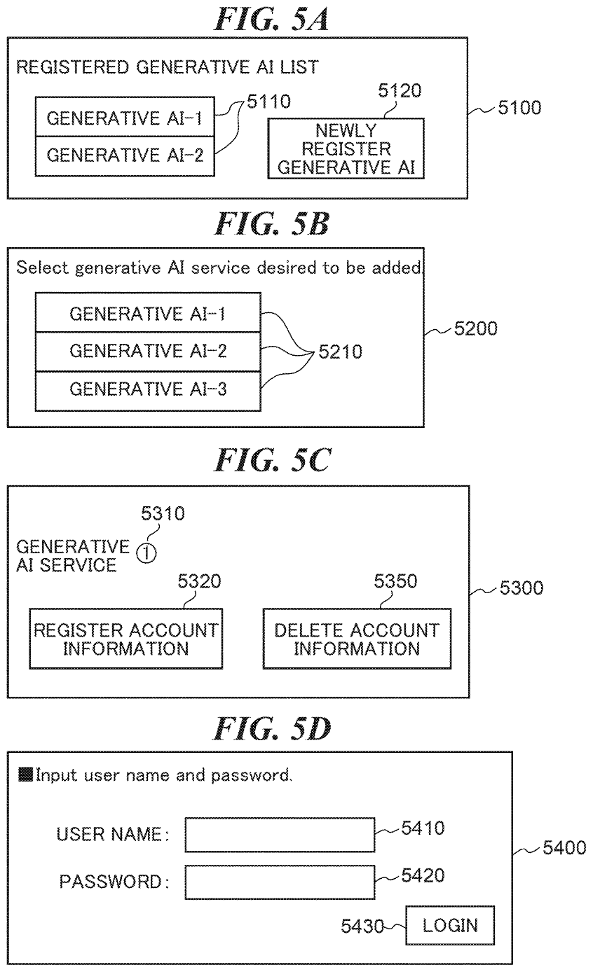

FIGS. 5A to 5D are diagrams showing an example of screens for setting a generative AI used in the information processing system. The screens shown in FIG. 5A to 5D are user interfaces for the generative AI-setting section 3111 and are displayed on the operation display 2160. A generative AI-setting screen 5100 shown in FIG. 5A includes a generative AI list 5110 and a button 5120. In the generative AI list 5110, generative AIs which can be used in the information processing system 100 are displayed in a list. Each generative AI in the generative AI list 5110 has been registered in the information processing apparatus 101, i.e. has been stored in the storage 2140. The button 5120 is pressed in a case where a generative AI for use in the information processing system 100 is newly registered. By pressing the button 5120, a new registration screen 5200 shown in FIG. 5B is displayed. The new registration screen 5200 includes a generative AI list 5210. The generative AI list 5210 includes the generative AI which can be newly used in the information processing system 100. Then, the user can select the generative AI in the generative AI list 5210. Note that the generative AI included in the generative AI list 5210 is set by the application 3110. Further, by selecting the generative AI in the generative AI list 5210, a new generative AI-setting screen 5300 shown in FIG. 5C is displayed.

The new generative AI-setting screen 5300 includes a label 5310, a button 5320, and a button 5350. The label 5310 is a designation of the generative AI selected from the generative AI list 5210. The button 5320 is pressed in a case where account information is registered. By registering the account information in advance, i.e. by storing the account information in the storage 2140 of the information processing apparatus 101, the user can omit a login operation performed whenever the generative AI indicated by the label 5310 is used. Further, before using the generative AI indicated by the label 5310, the user can check omission of registration of an account with the service of this generative AI. By pressing the button 5320, an authentication screen 5400 shown in FIG. 5D is displayed. The button 5350 is pressed in a case where account information which has been registered is deleted. The authentication screen 5400 includes a user name input section 5410, a password input section 5420, and a button 5430. In the user name input section 5410, a designation (user name) of a user using the generative AI indicated by the label 5310 is input by using characters and/or the like. In the password input section 5420, a password associated with the user name input in the user name input section 5410 is input by using characters and/or the like. The button 5430 is pressed in a case where the user logs into the generative AI service in a state in which the user name has been input in the user name input section 5410 and the password has been input in the password input section 5420. Then, when registration is completed by performing authentication, the screen returns to the new generative AI-setting screen 5300.

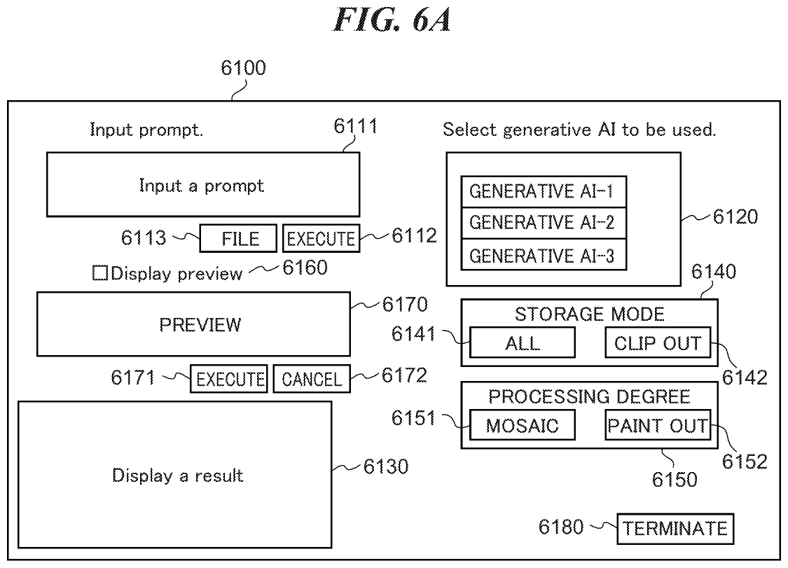

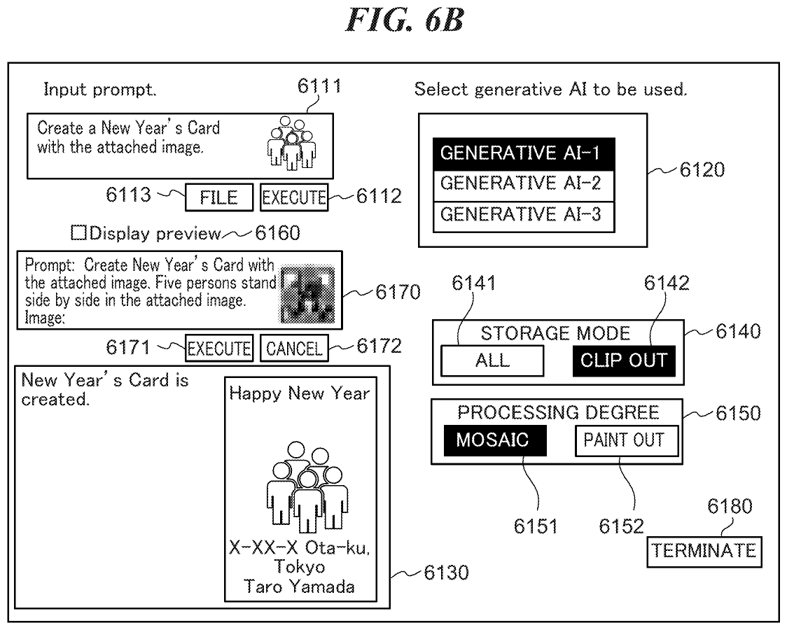

FIGS. 6A and 6B are diagrams each showing an example of a prompt execution screen (GUI) displayed in a case where a desired result is obtained by using the generative AI. FIG. 6A shows a state of a prompt execution screen 6100 before an operation. FIG. 6B shows a state of the prompt execution screen 6100 after the operation. The prompt execution screen 6100 is a user interface for the prompt execution section 3112 and is displayed on the operation display 2160. As shown in FIG. 6A, the prompt execution screen 6100 includes a text box 6111, an execution button 6112, a file selection button 6113, a generative AI area (model selection section) 6120, a text box 6130, and a storage setting area 6140. Further, the prompt execution screen 6100 includes a processing degree-setting area (processing selection section) 6150, a preview display checkbox 6160, a preview display 6170, an execution button (instruction section) 6171, a cancel button 6172, and a termination button 6180.

In the text box 6111, a first prompt is input. Note that although in the present embodiment, the first prompt is input in the text box 6111 in the text format, this is not limitative, but, for example, the first prompt can be input in an image file format, such as PDF. The execution button 6112 is pressed in a case where the first prompt input in the text box 6111 is executed. With this operation, the first prompt is received (reception step). Thus, in the present embodiment, the prompt execution section 3112 also functions as a reception unit for receiving the first prompt. The file selection button 6113 is pressed in a case where a variety of files, such as an image file, are attached to the first prompt. With this operation, a file selection screen (not shown) for selecting an attached file is displayed. Then, by selecting a desired attached file from the file selection screen, it is possible to attach the attached file to the first prompt. Note that an image included in the first prompt is the above-described unprocessed image.

In the generative AI display area 6120, the generative AIs which can be used in the information processing system 100 are displayed in a list. In this generative AI display area 6120, the same generative AIs as those displayed on the generative AI-setting screen 5100 are displayed. Then, the user can perform an operation of selecting at least one generative AI from the plurality of generative AIs included in the generative AI display area 6120. Note that in the present embodiment, the generative AI-setting screen 5100 can be displayed in place of the generative AI display area 6120. In the text box 6130, a result output from the generative AI 3210 of the cloud 103 for a second prompt is displayed. Note that although in the present embodiment, the output result is displayed in the text box 6130 in the text format, this is not limitative, but for example, the output result can be output in the file format of an image, such as PDF.

In the storage setting area 6140, the user can select a storage format of an image file to be attached to the first prompt by the file selection button 6113. In the storage area-setting area 6140, a button 6141 and a button 6142 are included and displayed (display step). The button 6141 is pressed in a case where an editing operation on an image selected by the file selection button 6113 is omitted. With this operation, the image selected by the file selection button 6113 is stored in the image data group 3114 as it is. The button 6142 is pressed in a case where the image selected by the file selection button 6113 is to be edited by the prompt execution section 3112. With this operation, the prompt execution section 3112 clips out predetermined part from the image selected by the file selection button 6113 and stores this clipped part in the image data group 3114. Note that the clipped shape is not particularly limited, and for example, the predetermined part can be clipped in a circular shape, a rectangular shape, a human body shape, or the like. Further, the storage setting area 6140 can include e.g. a button for storing an image in a low-resolution state.

In the processing degree-setting area 6150, the user can select a method of processing an image to be included in the second prompt. Note that the image included in the second prompt is the above-described processed image. Further, the information processing apparatus 101 determines whether or not an image as the personal identification information is included in the first prompt input in the text box 6111. This determination is performed by the generative AI 3120 of the information processing apparatus 101. Then, as a result of the determination performed by the generative AI 3120, if it is determined that an image as the personal identification information is included in the first prompt, this image is processed by the generative AI 3120. This processed image is included in the second prompt. Thus, the second prompt is generated (generation step). In the processing degree-setting area 6150, a button 6151 and a button 6152 are included and displayed (display step). The button 6151 is pressed in a case where mosaic processing is executed on at least part of an image to be included in the second prompt. Then, with this mosaic processing, the personal identification information is converted to concealed information. Note that the resolution of an image in mosaic processing can be adjusted. The button 6152 is pressed in a case where paint-out processing is executed on at least part of an image to be included in the second prompt. Not that a color used in the paint-out processing can be one color or can be selected from a plurality of colors. Further, the processing degree-setting area 6150 can include, for example, a button for being pressed in a case where blur processing is executed on at least part of an image to be included in the second prompt. In the present embodiment, the prompt execution section 3112 is capable of executing mosaic processing, blur processing, and paint-out processing. Note that the information processing apparatus 101 is only required to be capable of executing at least one of mosaic processing, blur processing, and paint-out processing, and as part on which the processing is executed, for example, part based on which a person can be identified is preferable.

In the preview display 6170, a preview image of the second prompt to be transmitted to the generative AI 3210 of the cloud 103 is displayed (display step). Further, the preview display checkbox 6160 is a box for selecting whether or not to display the preview of the second prompt in the preview display 6170 before transmission of the second prompt. In a case where the preview display checkbox 6160 is checked, the preview of the second prompt is displayed in the preview display 6170. On the other hand, in a case where the preview display checkbox 6160 is not checked, the preview of the second prompt is not displayed in the preview display 6170. Note that a toggle button can be used in place of the preview display checkbox 6160. The execution button 6171 is pressed in a case where transmission of the second prompt to the generative AI 3210 of the cloud 103 is instructed. The cancel button 6172 is pressed in a case where transmission of the second prompt to the generative AI 3210 of the cloud 103 is cancelled. Note that the execution button 6171 and the cancel button 6172 are displayed in a case where the preview display checkbox 6160 is checked. The termination button 6180 is pressed in a case where the display of the prompt execution screen 6100 is terminated. With this operation, the prompt execution screen 6100 is closed.

In the use state of the prompt execution screen 6100 shown in FIG. 6B, “Create a New Year's Card with the attached image.” as the first prompt is input in the text box 6111. Further, a group image in which five persons gather is attached to the first prompt. In a case where an image is attached, it is possible to attach the image by pressing the file selection button 6113. Further, respective faces of the five persons appear in the group image, and each face is determined as personal identification information, i.e., it is determined that the personal identification information is included in the group image. In this case, the user can select the storage format of the image file by pressing the button 6141 or the button 6142 in the storage setting area 6140 and select the processing method by pressing the button 6151 or the button 6152 in the processing degree-setting area 6150. FIG. 6B shows a state in which the button 6142 and the button 6151 have been pressed by way of example.

The preview display checkbox 6160 is checked. With this, the preview of the second prompt is displayed in the preview display 6170. Similar to the first prompt, the second prompt includes the instruction “Create a New Year's Card with the attached image.”. Further, a face determined as the personal identification information in the first prompt has been subjected, in the second prompt, to the mosaic processing according to the instruction provided by the button 6151 in the processing degree-setting area 6150, i.e. based on the instruction provided by the button 6151. Thus, in the second prompt, the personal identification information is converted to (replaced with) the concealed information from which the personal identification information can be concealed by performing the mosaic processing. Further, the second prompt includes outline information indicating the personal identification information. The outline information is displayed e.g. in characters “Five persons stand side by side in the attached image.”. Further, the outline information is preferably information explaining the personal identification information at a degree at which the personal identification information can be concealed, i.e., information which does not include the personal identification information. Here, the “degree at which the personal identification information can be concealed” refers to e.g. a degree at which it is difficult to identify a person e.g. through the senses of viewing and hearing. For example, a person is identified from a photograph including the respective faces of the persons, but, on the other hand, a person is not identified from the character string of “Five persons stand side by side in the attached image.”, unless e.g. a designation of each person is included.

Further, by pressing the execution button 6112, selection of the generative AI in the generative AI display area 6120 is prompted. With this, for example, the user can select “generative AI-1” in the generative AI display area 6120. Further, by pressing the execution button 6171, the user can transmit the second prompt to the cloud 103 via the communication I/F 2150 (transmission step). Thus, in the present embodiment, the communication I/F 2150 functions as a transmission unit for transmitting the second prompt. Then, the cloud 103 receives the second prompt from the information processing apparatus 101 via the communication I/F 2250. As a result, the second prompt is input to the generative AI 3210 of the cloud 103. Note that the generative AI 3210 is the “generative AI-1” selected in the generative AI display area 6120. This generative AI 3210 performs an output according to the second prompt. This output result is received via the communication I/F 2150 of the information processing apparatus 101 (reception step). Thus, in the present embodiment, the communication I/F 2150 also functions as a transmission receiving unit for receiving an output result from the generative AI 3210. Further, the output result includes the concealed information in the second prompt as it is. The prompt execution section 3112 converts, i.e., restores the concealed information to the personal identification information on the output result (conversion step). Thus, in the present embodiment, the prompt execution section 3112 functions as a conversion unit for converting the concealed information to the personal identification information. In the text box 6130, a New Year's Card including the group image in which the mosaiced faces have been converted to the state before being mosaiced is displayed as the output result in the state in which the concealed information has been converted to the personal identification information (display step). On the other hand, in a case where the cancel button 6172 is pressed, transmission of the second prompt is cancelled.

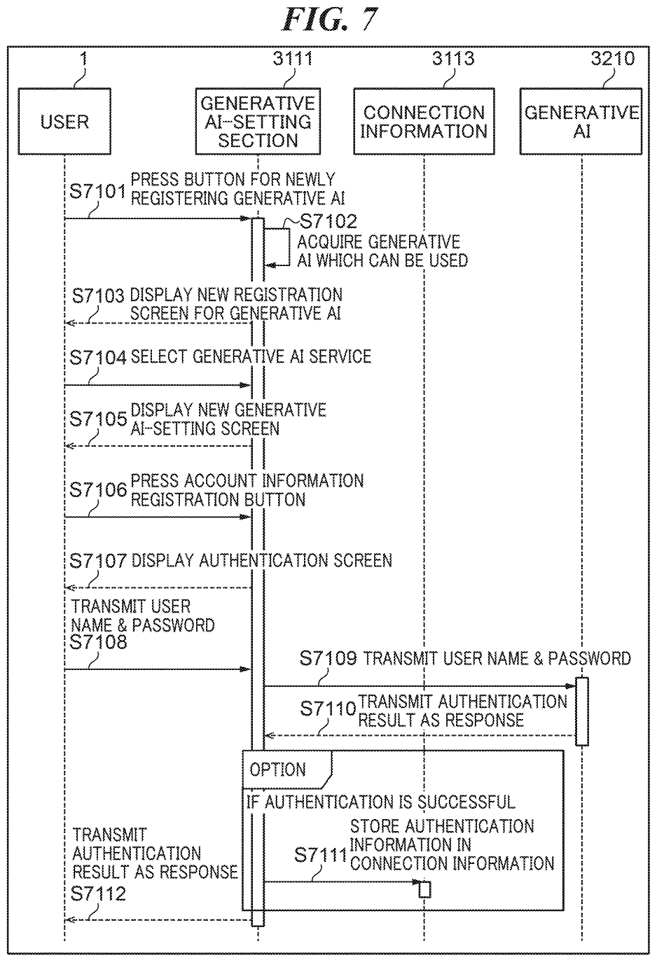

FIG. 7 is a sequence diagram showing a process executed between a user 1, the generative AI-setting section 3111, the connection information 3113, and the generative AI 3210. A program for executing the process shown in FIG. 7 is called from the ROM 2120. The CPU 2110 loads this program into the RAM 2130 and executes the loaded program. As shown in FIG. 7, in a step S7101, the user 1 presses the button 5120 on the generative AI-setting screen 5100 (see FIG. 5A) displayed on the operation display 2160.

In a step S7102, the generative AI-setting section 3111 acquires information related to the generative AI which can be used in the information processing system 100 according to the operation of pressing the button 5120, which is performed in the step S7101. This information is held in the generative AI-setting section 3111 in a predetermined format. Note that the storage location of the information is not limited to the generative AI-setting section 3111, but, for example, the information can be stored in a storage device outside the information processing apparatus 101.

In a step S7103, the generative AI-setting section 3111 displays the new registration screen 5200 (see FIG. 5B) on the operation display 2160 according to the operation of pressing the button 5120, which is performed in the step S7101. With this, the user 1 is enabled to perform an operation on the new registration screen 5200.

In a step S7104, the user 1 selects a generative AI service from the generative AI list 5210 on the new registration screen 5200.

In a step S7105, the generative AI-setting section 3111 displays the new generative AI-setting screen 5300 (see FIG. 5C) associated with the generative AI selected in the step S7104 on the operation display 2160. With this, the user 1 is enabled to perform an operation on the new generative AI-setting screen 5300.

In a step S7106, the user 1 presses the button 5320 on the new generative AI-setting screen 5300.

In a step S7107, the generative AI-setting section 3111 displays the authentication screen 5400 (see FIG. 5D) according to the operation of pressing the button 5320, which is performed in the step S7106. With this, the user 1 is enabled to perform an operation on the authentication screen 5400.

In a step S7108, the user 1 inputs a user name in the user name input section 5410 and inputs a password in the password input section 5420 on the authentication screen 5400. After that, the user 1 presses the button 5430 on the authentication screen 5400. With this operation, the user name input in the user name input section 5410 and the password input in the password input section 5420 are transmitted to the generative AI-setting section 3111.

In a step S7109, the generative AI-setting section 3111 receives the user name and the password, transmitted in the step S7108. Then, the generative AI-setting section 3111 transmits the received user name and password to the generative AI 3210.

In a step S7110, the generative AI 3210 receives the user name and the password, which are transmitted in the step S7109. The generative AI 3210 performs authentication on the received user name and password and transmits a result of the authentication to the generative AI-setting section 3111.

In a step S7111, the generative AI-setting section 3111 receives the authentication result transmitted in the step S7110. Then, in a case where this authentication result indicates that the authentication is successful, the authentication information is stored in the connection information 3113.

In a step S7112, the generative AI-setting section 3111 displays the authentication result transmitted in the step S7110 on the operation display 2160. With this, the user 1 can confirm the authentication result. Further, the setting of the generative AI is completed.

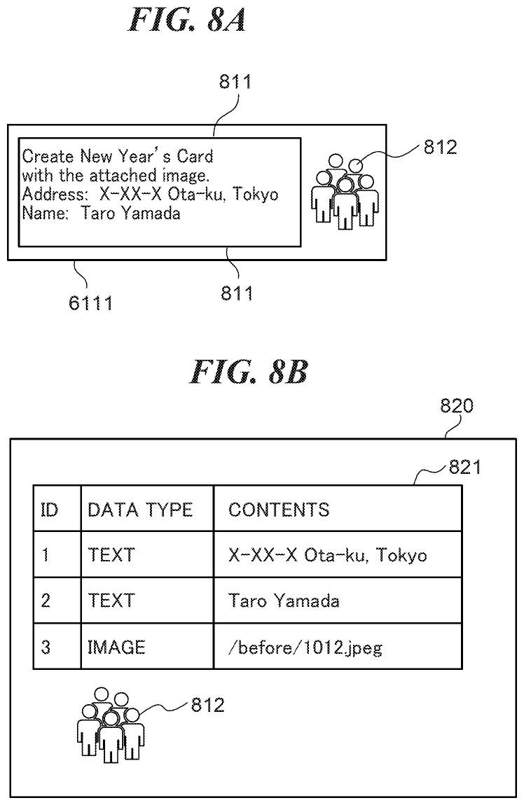

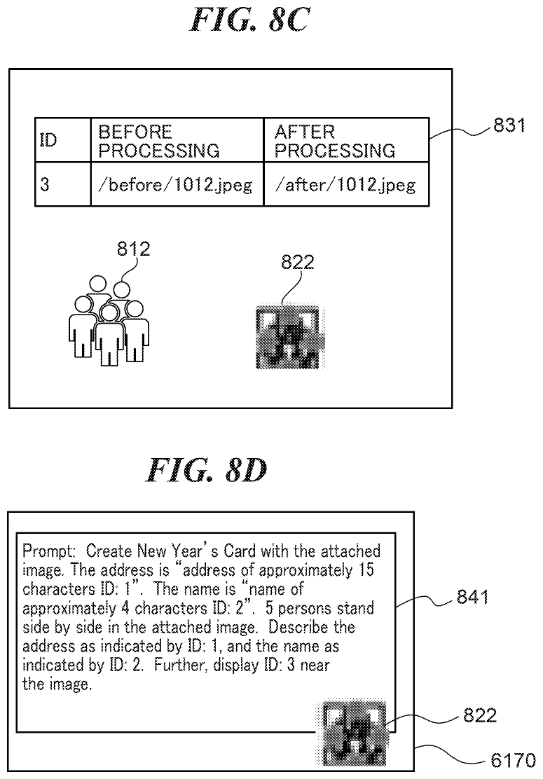

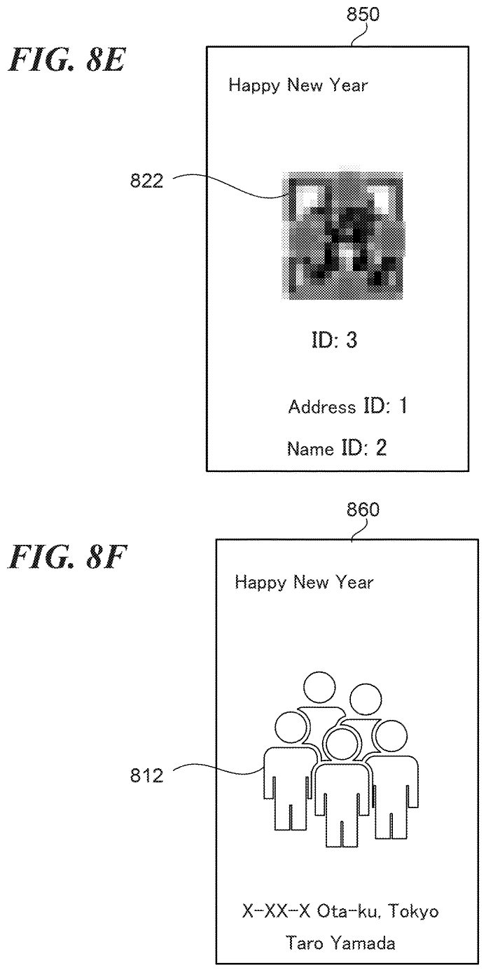

FIGS. 8A to 8F are diagrams showing an example of varying states of the personal identification information. As shown in FIG. 8A, a first prompt including character information 811 and an image 812 is input in the text box 6111 on the prompt execution screen 6100. The character information 811 is “Create a New Year's Card with the attached image. Address: X-XX-X Ota-ku, Tokyo Name: Taro Yamada”. The image 812 is a group image in which five persons gather. In the group image, respective faces of the five persons appear. As shown in FIG. 8B, it is determined that “X-XX-X Ota-ku, Tokyo” and “Taro Yamada” are included in the character information 811 as personal identification information, and it is determined that the face of each person is included in the image 812 as personal identification information. This determination is performed by the generative AI 3120. Then, the generative AI 3120 transmits the character information 811 including the personal identification information and the image 812 including the personal identification information to the prompt execution section 3112. The prompt execution section 3112 registers the personal identification information in a table 821.

As shown in FIG. 8C, the image 812 as an unprocessed image is processed into an image 822 as a processed image. For example, mosaic processing is performed on the face of each person included in the image 812 based on the instruction provided by the button 6151 in the processing degree-setting area 6150. With this, in a case where the personal identification information is an image, the personal identification information included in the image 812 is replaced with concealed information which prevents a person from being identified from each face, such as in the image 822. Note that in a table 831, a storage location “/before/1012.jpeg” of the image 812 and a storage location “/after/1012.jpeg” of the image 812 are registered. As shown in FIG. 8D, the preview of the second prompt including character information 841 is displayed in the preview display 6170 on the prompt execution screen 6100. In the second prompt, the personal identification information “X-XX-X Ota-ku, Tokyo” of the character information 811 is replaced with “address of approximately 15 characters ID: 1”, and the personal identification information “Taro Yamada” is replaced with “name of approximately 4 characters ID: 2”. Note that “address of approximately 15 characters ID: 1” replaced from the specific address and “name of approximately 4 characters ID: 2” replaced from the specific personal name are an example of the concealed information, and are pieces of information with which the original pieces of information are replaced to thereby prevent a person from being identified. Each replacement is performed by the generative AI 3120. Further, the character information 841 includes “Create a New Year's Card with the attached image.” and “Display ID: 3 near the image.”. Further, the second prompt includes the image 822 in which the personal identification information has been mosaiced. As the outline information of this personal identification information, “Five persons stand side by side in the attached image.” is included in the character information 841. This second prompt is transmitted to the cloud 103 and input to the generative AI 3210.

As shown in FIG. 8E, an image 850 as a result of execution of the second prompt is output from the generative AI 3210. The image 850 includes “Happy New Year”, “ID: 1”, “ID: 2”, and the image 822. Note that although in the present embodiment, the image 822 of the second prompt is included in the image 850, this is not limitative, but, for example, the image 822 can be omitted. In the second prompt, the personal identification information is replaced with the concealed information, but it is preferable to omit the image 822 from the image 850 for further concealing the personal identification information (image 812) as the original information replaced with the concealed information. Further, the image 822 (particularly, the face part) can be omitted from the second prompt itself transmitted to the cloud 103. This case is also preferable in further concealing the personal identification information (image 812). As shown in FIG. 8F, in an image 860, the concealed information “ID: 1” in the image 850 is converted to the personal identification information “X-XX-X Ota-ku, Tokyo”, and the concealed information “ID: 2” is converted to the personal identification information “Taro Yamada”. Further, in the image 860, the image 822 as the mosaiced image, i.e., the processed image is converted to the image 812 as the unprocessed image.

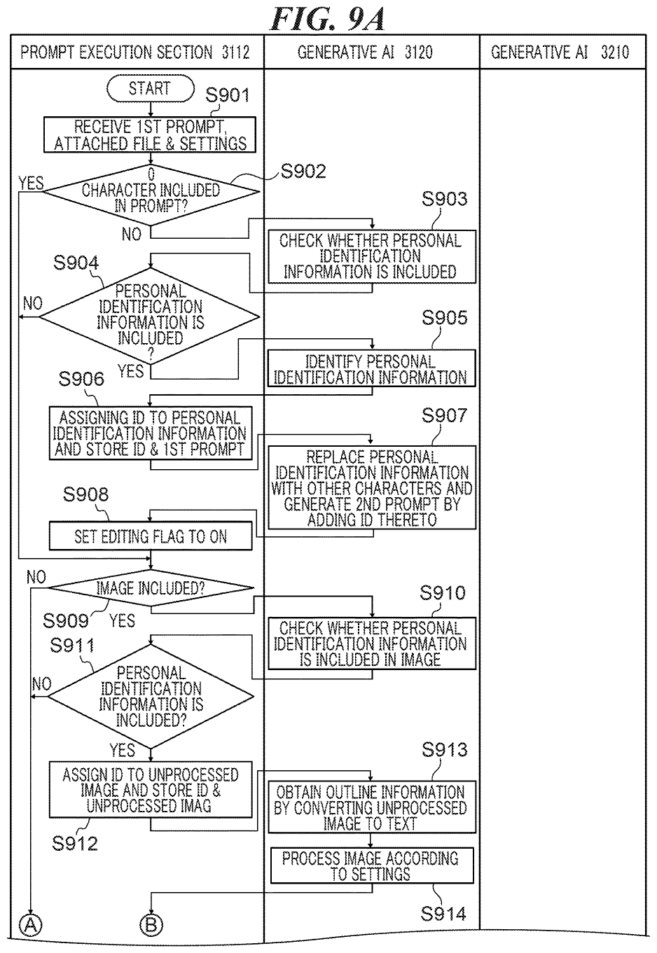

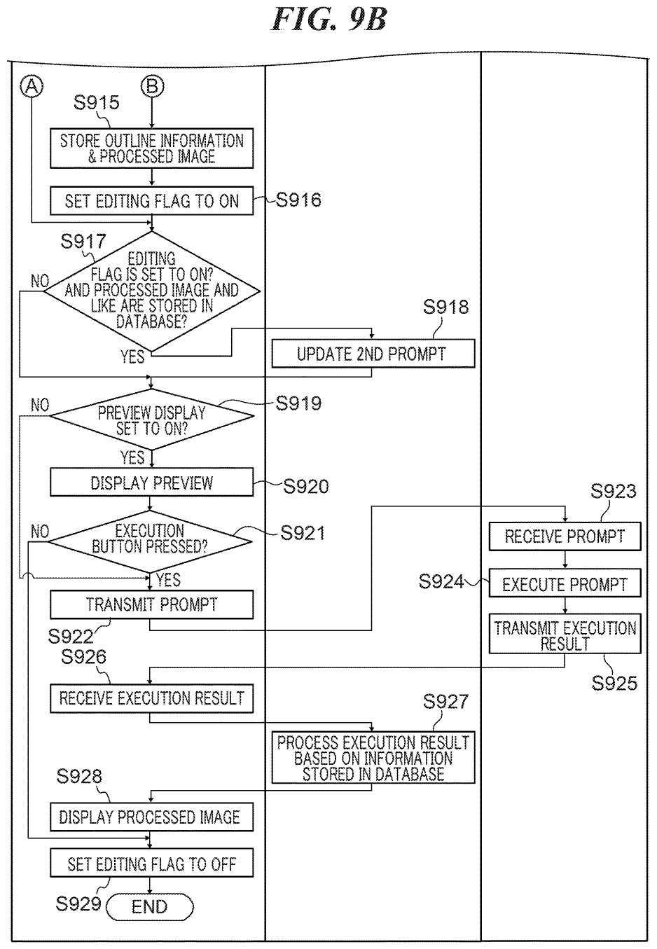

FIGS. 9A and 9B are flowcharts of a process performed by the information processing apparatus 101 and the cloud 103. A program for part of the process shown in FIGS. 9A and 9B, which is executed by the information processing apparatus 101, is stored in the ROM 2120 of the information processing apparatus 101. The CPU 2110 of the information processing apparatus 101 calls the program from the ROM 2120, loads the program into the RAM 2130, and executes the loaded program. Further, a program for part of the process shown in FIG. 9, which is executed by the cloud 103 is stored in the ROM 2220 of the cloud 103. The CPU 2210 of the cloud 103 calls the program from the ROM 2220, loads the program into the RAM 2230, and executes the loaded program. Further, the generative AI-setting section 3111, the prompt execution section 3112, and the generative AI 3120 are controlled by the CPU 2110 of the information processing apparatus 101. The generative AI 3210 is controlled by the CPU 2210 of the cloud 103.

Referring to FIG. 9A, in a step S901, in a case where the execution button 6112 on the prompt execution screen 6100 is pressed, the prompt execution section 3112 acquires a variety of input information on the prompt execution screen 6100. Specifically, the prompt execution section 3112 acquires the first prompt input in the text box 611 on the prompt execution screen 6100 and the attached file selected by the file selection button 6113. Further, the prompt execution section 3112 acquires information on (settings of) the generative AI selected in the generative AI display area 6120 and the image file storage format selected in the storage setting area 6140. Further, the prompt execution section 3112 acquires information on (settings of) the image processing method selected in the processing degree-setting area 6150 and whether or not the preview display checkbox 6160 is checked. Note that although in the present embodiment, the input to a prompt execution section 3112 is performed via the prompt execution screen 6100 of the prompt, this is not limitative, but for example, the input can be performed from a predetermined application via an API.

In a step S902, the prompt execution section 3112 determines whether or not the number of characters included in the first prompt acquired in the step S901 is 0. If it is determined in the step S902 that the number of characters is 0, the process proceeds to a step S909. On the other hand, if it is determined in the step S902 that the number of characters is not 0, the process proceeds to a step S903. Note that in a case where a character code which cannot be displayed, such as a line-feed code, is included in the first prompt, it can be determined that that the number of characters is 0, or it can be determined that that the number of characters is not 0, i.e., such a code can be excluded from the condition for determining the number of characters.

In the step S903, the generative AI 3120 check whether personal identification information is included in the first prompt acquired in the step S901. The personal identification information checked in this step is e.g. a name and an address.

In a step S904, the prompt execution section 3112 determines, based on the check in the step S903, whether or not personal identification information is included in the first prompt acquired in the step S901. If it is determined in the step S904 that personal identification information is included, the process proceeds to a step S905. On the other hand, if it is determined in the step S904 that personal identification information is not included, the process proceeds to the step S909.

In the step S905, the generative AI 3120 identifies the personal identification information determined in the step S904.

In a step S906, the prompt execution section 3112 assigns a unique ID to the personal identification information identified in the step S905 and stores this ID (personal identification information) and the first prompt in the database 3115 (storage step) Note that at this time, the prompt execution section 3112 stores a correspondence relationship between the personal identification information and the ID assigned to the personal identification information e.g. in the storage 2140.

In a step S907, the generative AI 3120 replaces the personal identification information with concealed information and generates a second prompt by embedding the ID assigned in the step S906. For example, in a case where “X-XX-X Ota-ku, Tokyo” is included in the first prompt as the personal identification information, the generative AI 3120 assigns an ID “0001”. Further, the generative AI 3120 replaces “X-XX-X Ota-ku, Tokyo” with “Address of approximately 15 characters. Describe ID 0001 in an output.” as the concealed information. Note that although in the present embodiment, the concealed information is described as “Address of approximately 15 characters”, this is not limitative, but, for example, “number and names of village, town, city, and prefecture”, “name of building, number, and names of village, town, city, and prefecture”, “ [symbol] ” or the like can be described. Further, the personal identification information can be identified by different IDs before and after replacement.

In a step S908, the prompt execution section 3112 sets the editing flag 3116 to ON.

In the step S909, the prompt execution section 3112 determines whether or not an image is included in the first prompt acquired in the step S901. If it is determined in the step S909 that an image is included, the process proceeds to a step S910. On the other hand, if it is determined in the step S909 that an image is not included, the process proceeds to a step S917 in FIG. 9B.

In the step S910, the generative AI 3120 checks whether personal identification information is included in the image determined in the step S909. The personal identification information checked in this step is e.g. a face.

In a step S911, the prompt execution section 3112 determines, based on the check in the step S910, whether or not personal identification information is included in the image determined in the step S909, i.e., in the unprocessed image. If it is determined in the step S911 that personal identification information is included, the process proceeds to a step S912. On the other hand, if it is determined in the step S911 that personal identification information is not included, the process proceeds to the step S917.

In the step S912, the prompt execution section 3112 assigns a unique ID to the unprocessed image, stores this ID in the database 3115, and stores the unprocessed image in the image data group 3114. Note that the storage format of the unprocessed image stored in the image data group 3114 is based on the information on the storage format of the image file, which is acquired in the step S901.

In a step S913, the generative AI 3120 converts the unprocessed image stored in the step S912 to characters (text). With this, the outline information indicating the personal identification information is obtained. For example, in a case where the unprocessed image stored in the step S912 is the image 812 (see FIG. 8A), this image 812 is converted to text “In the image, there appear two persons standing side by side in a back row, and three persons standing side by side in a front row.”.

In a step S914, the generative AI 3120 processes the unprocessed image. With this, a processed image is obtained. Note that the processing in the step S914 is performed based on the information on the image processing method, which is selected in the processing degree-setting area 6150 and acquired in the step S901. In a case where the button 6151 is selected in the processing degree-setting area 6150, the generative AI 3120 performs mosaic processing on the unprocessed image.

In a step S915 in FIG. 9B following the step S914, the prompt execution section 3112 stores the outline information obtained in the step S913 and the processed image obtained in the step S914 in the database 3115.

In a step S916, the prompt execution section 3112 sets the flag of the editing flag 3116 to ON.

In the step S917, the prompt execution section 3112 determines whether or not the flag of the editing flag 3116 is set to ON, and at the same time the processed image and the like have been stored in the database 3115. If it is determined in the step S917 that the flag is set to ON and that the processed image and the like have been stored, the process proceeds to a step S918. On the other hand, if it is determined that the flag is set to OFF or that the processed image and the like have not been stored, the process proceeds to a step S919.

In the step S918, the prompt execution section 3112 updates the second prompt based on the outline information and the processed image, which are stored in the step S915. Specifically, the prompt execution section 3112 converts the character information 811 (see FIG. 8A) of the first prompt to the character information 841 (see FIG. 8D) and converts the image 812 (see FIG. 8A) of the first prompt to the image 822 (see FIG. 8D). As a result, the second prompt is updated.

In the step S919, the prompt execution section 3112 determines whether or not the preview display checkbox 6160 is checked (preview is ON) based on the information on whether or not the preview display checkbox 6160 is checked, which is acquired in the step S901. If it is determined in the step S919 that the preview display checkbox 6160 is checked, the process proceeds to a step S920. On the other hand, if it is determined in the step S919 that the preview display checkbox 6160 is not checked, the process proceeds to a step S922.

In the step S920, the prompt execution section 3112 displays the preview of the second prompt generated in the step S918 in the preview display 6170 on the prompt execution screen 6100.

In a step S921, the prompt execution section 3112 determines whether or not the execution button 6171 on the prompt execution screen 6100 is pressed. If it is determined in the step S921 that the execution button 6171 is pressed, the process proceeds to the step S922. On the other hand, if it is determined in the step S921 that the execution button 6171 is not pressed, i.e., the cancel button 6172 is pressed, the process proceeds to a step S929.

In the step S922, the prompt execution section 3112 transmits the second prompt generated in the step S918, based on the information on the generative AI selected in the generative AI display area 6120, which is acquired in the step S901. The transmission destination of the second prompt is the generative AI (the generative AI 3210 in this example) selected in the generative AI display area 6120.

In a step S923, the generative AI 3210 receives the second prompt transmitted in the step S922, i.e. the second prompt is input to the generative AI 3210.

In a step S924, the generative AI 3210 executes the second prompt input in the step S923. With this, an output result (execution result) associated with the second prompt is obtained.

In a step S925, the generative AI 3210 transmits the output result obtained in the step S924 to the prompt execution section 3112 of the information processing apparatus 101.

In a step S926, the prompt execution section 3112 receives the output result transmitted in the step S925.

In a step S927, the output result received in the step S926 is input to the generative AI 3120. Then, the generative AI 3120 processes the output result. Specifically, the generative AI 3120 converts “ID: 1” included in the image 850 to “X-XX-X Ota-ku, Tokyo” registered in the database 3115. Further, the generative AI 3120 converts “ID: 2” included in the image 850 to “Taro Yamada” registered in the database 3115. Further, the generative AI 3120 converts “ID: 3” included in the image 850 to the image 812 registered in the database 3115. As a result of this conversion, the image 860 is obtained. Note that the generative AI 3120 can further perform other processing than the above-described conversion processing on the image 850. Further, in a case where the mosaiced image is not included in the output result (image 850) received from the generative AI 3210, the image 850 can be processed based on the output result, i.e., design of a product and margin information.

In a step S928, the prompt execution section 3112 displays the image 860 obtained in the step S927 in the text box 6130 on the prompt execution screen 6100. With this, the user can confirm the image 860.

In the step S929, the prompt execution section 3112 sets the flag of the editing flag 3116 to OFF, followed by terminating the process.

As described above, in the information processing apparatus 101, when a first prompt is transmitted, first, whether or not personal identification information is included in the first prompt is determined. As a result of this determination, if it is determined that personal identification information is included in the first prompt, a second prompt in which the personal identification information is replaced with concealed information is generated. With this, it is possible to transmit the second prompt to the generative AI 3210 of the cloud 103 in place of the first prompt including the personal identification information. Thus, in the information processing apparatus 101, it is possible to transmit a prompt to the cloud 103 without being conscious of whether or not personal identification information is included in the prompt.

Note that the output result received from the generative AI 3210 of the cloud 103 is not necessarily required to include the concealed information included in the transmitted second prompt. That is, for example, in a case where the personal identification information is an image, the image on which mosaic processing has been performed (concealed information) is included in the second prompt and input to the generative AI 3210, but this concealed information is not included in an answer (output) generated by the generative AI 3210. In this case, the answer is generated in a state in which an area including the concealed information is replaced with a predetermined mark, such as a blank. The information processing apparatus 101 having received this answer converts the output data by using the predetermined mark included in the answer. For example, the CPU 2110 of the information processing apparatus 101 converts the predetermined mark included in the received answer to the personal identification information (such as the image 812) stored in the step S906. With this, the concealed information which is input in a state in which the personal identification information has been converted is finally restored to the personal identification information again.

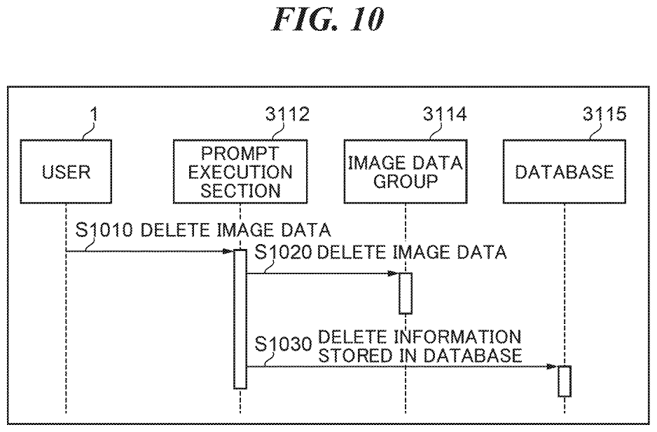

FIG. 10 is a sequence diagram showing a process executed between the user 1, the prompt execution section 3112, the image data group 3114, and the database 3115. As shown in FIG. 10, in a step S1010, the user 1 presses the termination button 6180 on the prompt execution screen 6100. With this, the prompt execution screen 6100 is closed.

In a step S1020, the prompt execution section 3112 deletes all images stored in the image data group 3114. With this, for example, it is possible to secure the free space in the image data group 3114.

In a step S1030, the prompt execution section 3112 deletes all data (information) registered in the database 3115. With this, for example, it is possible to secure the free space in the database 3115.

According to the present disclosure, when a prompt is transmitted, it is possible to transmit the prompt without being conscious of whether or not personal identification information based on which a person can be identified is included in this prompt.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-049659, filed Mar. 25, 2025, which is hereby incorporated by reference herein in its entirety.

What is claimed is:

1. A non-transitory computer-readable storage medium storing a program for executing a method of controlling an information processing apparatus communicably connected to an external apparatus having a learned model, the program causing a computer of the information processing apparatus to execute the method comprising:
receiving a first prompt;
transmitting, in a case where personal identification information is included in the first prompt, a second prompt to the external apparatus, the second prompt including concealed information formed by converting the personal identification information such that the personal identification information can be concealed, and outline information which is information indicating the personal identification information but does not include the personal identification information;
receiving an output result obtained by inputting the second prompt transmitted by the transmitting to the learned model; and
converting the concealed information included in the output result received by the receiving to the personal identification information.

2. The non-transitory computer-readable storage medium according to claim 1, wherein the method further comprises:
determining whether or not personal identification information based on which a person can be identified is included in the first prompt received by the receiving, and
generating the second prompt in a case where, as a result of the determining, it is determined that the personal identification information is included in the first prompt,
wherein the transmitting includes transmitting the second prompt generated by the generating to the external apparatus.

3. The non-transitory computer-readable storage medium according to claim 2, wherein the determining includes using the learned model which has learned the personal identification information.

4. The non-transitory computer-readable storage medium according to claim 2, wherein the generating includes generating the second prompt by causing the outline information to be included therein, the outline information including a character string explaining the personal identification information at a degree at which the personal identification information can be concealed.

5. The non-transitory computer-readable storage medium according to claim 2, wherein the personal identification information is an image, and
wherein the generating includes converting the personal identification information to the concealed information by executing at least one of processing operations of mosaic processing, blur processing, and paint-out processing, on at least part of the image.

6. The non-transitory computer-readable storage medium according to claim 5, wherein the receiving further receives selection of at least one of the mosaic processing, the blur processing, and the paint-out processing, and
wherein the generating includes executing the selected processing.

7. The non-transitory computer-readable storage medium according to claim 2, wherein the method further comprises displaying a preview of the second prompt generated by the generating.

8. The non-transitory computer-readable storage medium according to claim 7, wherein the receiving includes receiving an instruction for transmitting the second prompt to the external apparatus, and
wherein the transmitting includes transmitting the second prompt to the external apparatus upon receipt of the instruction.

9. The non-transitory computer-readable storage medium according to claim 7, wherein the preview displays the outline information including a character string explaining the personal identification information at a degree at which the personal identification information can be concealed.

10. The non-transitory computer-readable storage medium according to claim 1, wherein the converting includes adding the personal identification information to the output result received by the receiving.

11. The non-transitory computer-readable storage medium according to claim 2, wherein the method further comprises displaying the output result converted by the converting.

12. The non-transitory computer-readable storage medium according to claim 1, wherein the external apparatus has a plurality of types of the learned models, and
wherein the receiving includes receiving a learned model to be used, based on selection of at least one of the plurality of types of learned models.

13. The non-transitory computer-readable storage medium according to claim 1, wherein the method further comprises storing the personal identification information in a case where the personal identification information is included in the received first prompt, and
wherein the personal identification information stored by the storing can be deleted.

14. An information processing apparatus that is communicably connected to an external apparatus having a learned model, comprising:
a reception unit configured to receive a first prompt;
a transmission unit configured to transmit, in a case where personal identification information is included in the first prompt, a second prompt to the external apparatus, the second prompt including concealed information formed by converting the personal identification information such that the personal identification information can be concealed, and outline information which is information indicating the personal identification information but does not include the personal identification information;
a transmission receiving unit configured to receive an output result obtained by inputting the second prompt transmitted by the transmission unit to the learned model; and
a conversion unit configured to convert the concealed information included in the output result received by the transmission receiving unit to the personal identification information.

15. A method of controlling an information processing apparatus that is communicably connected to an external apparatus having a learned model, comprising:
receiving a first prompt;
transmitting, in a case where personal identification information is included in the first prompt, a second prompt to the external apparatus, the second prompt including concealed information formed by converting the personal identification information such that the personal identification information can be concealed, and outline information which is information indicating the personal identification information but does not include the personal identification information;
receiving an output result obtained by inputting the second prompt transmitted by the transmitting to the learned model; and
converting the concealed information included in the output result received by the receiving to the personal identification information.
